(19) United States
(12) Patent Application Publication
(10) Pub. No.: US 2012/0155085 A1
(43) Pub. Date: Jun. 21, 2012

(54) LED MODULE ASSEMBLING STRUCTURE

(76) Inventors: Chih-Yang CHANG, Taoyuan County (TW); Yu-Chun HSIEH, Nantou County (TW)

(21) Appl. No.: 12/973,222

(22) Filed: Dec. 20, 2010

(51) Int. Cl. F21S 4/00; F21V 21/00

(52) U.S. Cl. 362/249.02; 362/382

(57) ABSTRACT

An LED module assembling structure includes an LED module, at least one connection seat and a conductive connection member. The LED module includes a circuit board and at least one light-emitting diode. The connection seat is soldered on the circuit board. The connection seat has two sidewalls defining a holding trough having an opening. The sidewalls are respectively formed with two corresponding recesses and two corresponding latch protrusion sections protruding from the sidewalls into the holding trough. The latch protrusion sections are positioned above the recesses near the opening. The conductive connection member is a bar-shaped conductor. At least one end of the conductive connection member is inserted in the holding trough of the connection seat and fixedly held between the recesses in the holding trough. Accordingly, multiple LED modules can be assembled and electrically connected with each other via the conductive connection member and the connection seats.

### FIELD OF THE INVENTION

The present invention relates generally to an LED module assembling structure, and more particularly to an LED module assembling structure by which an LED module can be more securely electrically connected to an external power source or more than two LED modules can be assembled and electrically connected with each other.

### BACKGROUND OF THE INVENTION

A conventional LED light includes one or more than one LED module disposed in the LED light. Each LED module includes a circuit board and multiple light-emitting diodes (LEDs) electrically connected with the circuit board. When the LED module is electrically connected to an external power source, the LEDs will emit light. In the case that multiple LED modules are electrically connected with each other, the LEDs of the LED modules will all emit light. Conventionally, to electrically connect an LED module to an external power source or electrically connect multiple LED modules with each other, an electrical wire is soldered on the circuit board of the LED module to achieve the purpose of electrical connection. However, the electrical wire must be manually soldered on the circuit board. The soldering quality is unstable so that the lighting effect and lifetime of the LEDs will be affected. Moreover, it is necessary to use additional fixing members (such as screws) to assemble the LED modules with each other. Such assembling process is quite troublesome. Furthermore, the conventional electrical connector is generally used for data transmission. Such electrical connector is not suitable for assembling and electrically connecting the LED modules in volume and function. In addition, the conventional electrical connector has a complicated structure and is manufactured at high cost. This will lead to increase of the manufacturing cost of the LED light. This is not beneficial to the competitive ability of the product on the market.

It is therefore tried by the applicant to provide an LED module assembling structure to overcome the above problems. By means of the LED module assembling structure, an LED module can be more securely electrically connected to an external power source or more than two LED modules can be assembled and electrically connected with each other at the same time.

### SUMMARY OF THE INVENTION

A primary object of the present invention is to provide an LED module assembling structure. By means of the connection seats and the conductive connection members applied to the LED modules, the manufacturing process of the LED light is simplified and the manufacturing cost of the LED light is lowered. Moreover, the LED modules can be more securely electrically connected to an external power source or connected with each other to ensure the quality of the LED light.

According to the above and other objects, the LED module assembling structure of the present invention includes: an LED module including a circuit board and at least one light-emitting diode connected to the circuit board; at least one connection seat soldered on the circuit board of the LED module, the connection seat having a holding trough; and a conductive connection member, which is a conductor in the form of a bar. One end of the conductive connection member is inserted in the holding trough of the connection seat and fixedly held in the holding trough, whereby the conductive connection member is electrically connected with the LED module via the connection seat.

Still according to the above and other objects, the LED module assembling structure of the present invention includes: more than two LED modules each including a circuit board and at least one light-emitting diode connected to the circuit board; more than two connection seats respectively soldered on the circuit boards of the LED modules, each connection seat having a holding trough; and a conductive connection member, which is a conductor in the form of a bar. Two ends of the conductive connection member are respectively inserted in the holding troughs of the connection seats on the LED modules and fixedly held in the holding troughs, whereby the LED modules are electrically connected with each other via the conductive connection member and the connection seats.

The connection seat has two sidewalls defining the holding trough. The holding trough has an opening. The sidewalls are respectively formed with two corresponding recesses opposite to each other. The sidewalls are further respectively formed with two corresponding latch protrusion sections oppositely protruding from the sidewalls into the holding trough. The latch protrusion sections are positioned above the recesses near the opening.

The connection seat is made of metal material to directly electrically connect with the LED module. Alternatively, the connection seat includes an insulation seat and at least one piece of conductive terminal connected to the recess. The conductive terminal is electrically connected with the LED module.

The conductive connection member is a metal bar or electrical wire.

More than two LED modules can be connected with each other to form an elongated assembly or side by side connected with each other to form a rectangular assembly or radially arranged and connected with each other to form a circular assembly or connected with each other to form an annular assembly or form an assembly with an irregular shape.

In the LED module assembling structure of the present invention, by means of the connection seats and the conductive connection members, an LED module can be more securely electrically connected to an external power source or more than two LED modules can be assembled and electrically connected with each other at the same time. Therefore, the manufacturing process of the LED light is simplified and the manufacturing cost of the LED light is lowered. Moreover, the LED modules can be more securely electrically connected to an external power source or connected with each other to ensure the quality of the LED light.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first preferred embodiment of the present invention;

FIG. 2 is another perspective exploded view of the first preferred embodiment of the present invention;

FIG. 3 is a perspective view of the connection seat of the first preferred embodiment of the present invention in one aspect;

FIG. 4 is a perspective view of the connection seat of the first preferred embodiment of the present invention in another aspect;

FIG. 5 is a perspective exploded view of a second preferred embodiment of the present invention;

FIG. 6 is a perspective view of the second preferred embodiment of the present invention, showing the application thereof in one state;

FIG. 7 is a plane view of the second preferred embodiment of the present invention, showing the application thereof in another state;

FIG. 8 is a plane view of the second preferred embodiment of the present invention, showing the application thereof in still another state; and

FIG. 9 is a plane view of the second preferred embodiment of the present invention, showing the application thereof in still another state.

### DETAILED DESCRIPTION OF THE PREFERRED EMBODIMENTS

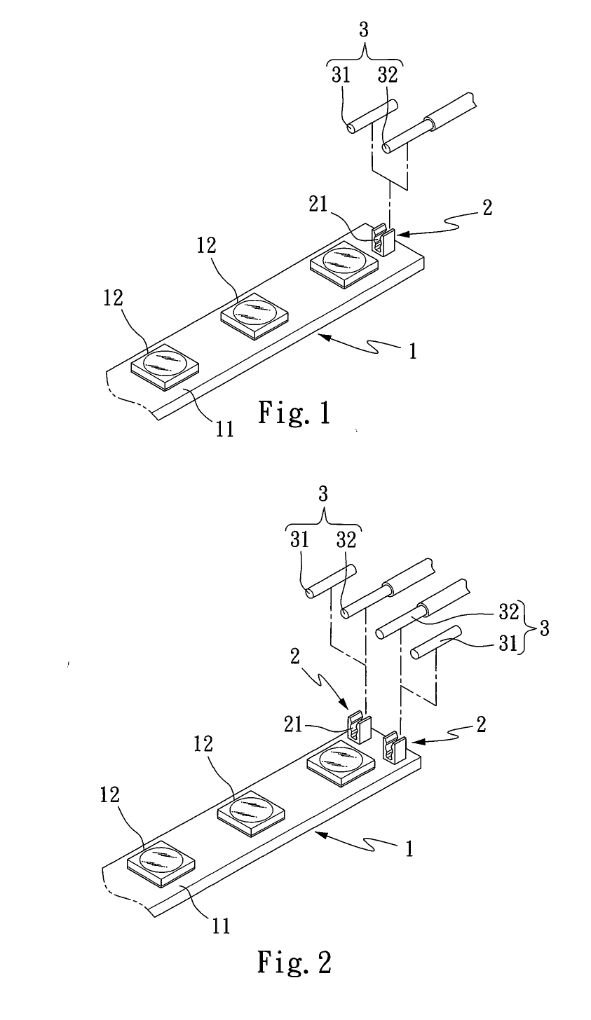

Please refer to FIGS. 1 to 3. According to a first preferred embodiment, the LED module assembling structure of the present invention includes an LED module 1, at least one connection seat 2 soldered on the LED module 1 and a conductive connection member 3. The LED module 1 includes a rectangular, sector-shaped or annular circuit board 11 and at least one light-emitting diode (LED) 12 connected to the circuit board 11. The connection seat 2 is soldered on the circuit board 11 of the LED module 1. The connection seat 2 has two sidewalls 212 defining a holding trough 21. The holding trough 21 has an opening 211. The sidewalls 212 are respectively formed with two corresponding recesses 213 opposite to each other. The sidewalls 212 are further respectively formed with two corresponding latch protrusion sections 214 oppositely protruding from the sidewalls 212 into the holding trough 21. The latch protrusion sections 214 are positioned above the recesses 213 near the opening 211. The connection seat 2 can be made of metal material to directly electrically connect with the circuit board 11 of the LED module 1. The conductive connection member 3 is a conductor in the form of a bar such as a metal bar 31 or an electrical wire 32. At least one end of the conductive connection member 3 is inserted in the holding trough 21 of the connection seat 2 and fixedly held between the recesses 213 in the holding trough 21. Accordingly, the conductive connection member 3 is electrically connected with the LED module 1 via the connection seat 2.

As shown in FIG. 4, according to another preferred embodiment, the connection seat 2 has an insulation seat 22 made of plastic material. The insulation seat 22 has two sidewalls 212 defining a holding trough 21 having an opening 211. The sidewalls 212 are also formed with two recesses 213 and two latch protrusion sections 214. The connection seat 2 further has at least one piece of conductive terminal 23 connected to the recess 213 of the sidewalls 212. The conductive terminal 23 is an arcuate metal plate adapted to the recess 213 for fixedly holding the conductive connection member 3 and electrically connecting the conductive connection member 3 with the circuit board 11 of the LED module 1.

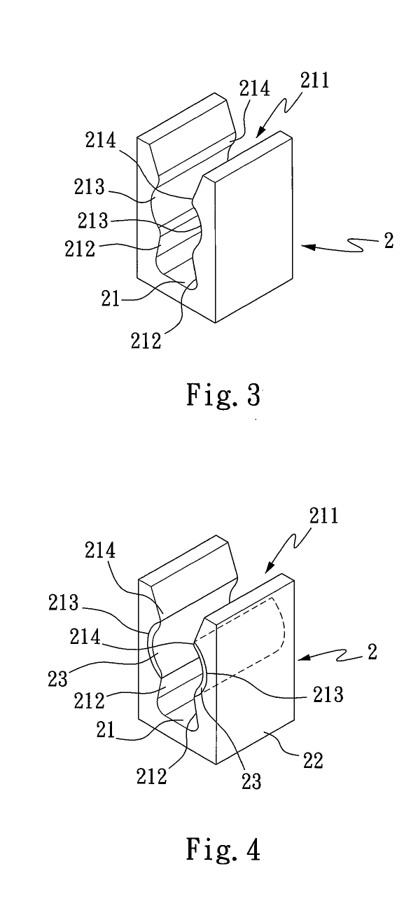

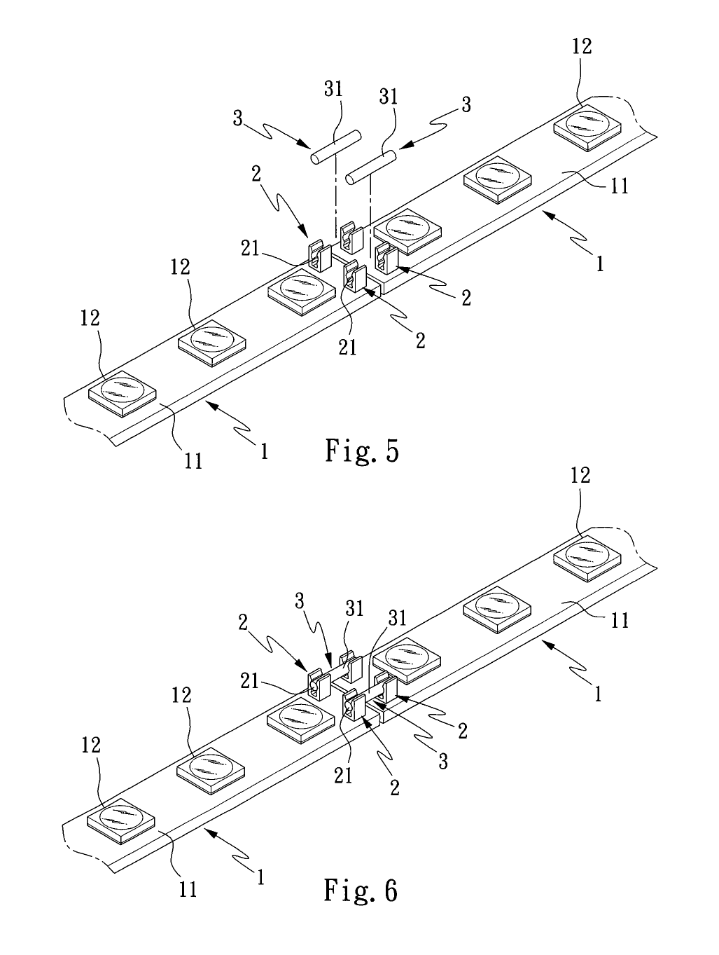

Please refer to FIGS. 5 and 6. According to a second preferred embodiment, the LED module assembling structure of the present invention includes more than two LED modules 1, more than two connection seats 2 soldered on the LED modules 1 and a conductive connection member 3. Each LED module 1 includes a circuit board 11 and at least one light-emitting diode (LED) 12 connected to the circuit board 11. The connection seat 2 is soldered on the circuit board 11 of the LED module 1. As the structure of FIG. 3, the connection seat 2 has two sidewalls 212 defining a holding trough 21. The holding trough 21 has an opening 211. The sidewalls 212 are also formed with two recesses 213 and two latch protrusion sections 214. Alternatively, as the structure of FIG. 4, the connection seat 2 has an insulation seat 22 and a conductive terminal 23. The conductive connection member 3 is a conductor in the form of a bar such as a metal bar 31 as shown in FIGS. 5 and 6. Two ends of the conductive connection member 3 (metal bar 31) are inserted in the holding troughs 21 of the connection seats 2 on the two LED modules 1 and fixedly held between the recesses 213 (conductive terminals 23) in the holding troughs 21. Accordingly, the two LED modules 1 are assembled and electrically connected with each other via the conductive connection member 3 and the connection seats 2 without using any conventional fixing member.

According to the above arrangement, as shown in FIGS. 1 and 2, the metal bar 31 or electrical wire 32 as the conductive connection member 3 is inserted into the holding trough 21 of the connection seat 2. At this time, the metal bar 31 or electrical wire 32 is fixedly held between the recesses 213 in the holding troughs 21. When the metal bar 31 or electrical wire 32 is further connected to an external power source, the LED module 1 is electrically connected to the external power source via the connection seat 2 and the conductive connection member 3. In this case, the LED 12 of the LED module 1 can emit light. The present invention is advantageous over the prior art in that the LED module 1 can be electrically connected to the external power source without manually soldering the electrical wire on the circuit board of the LED module 1. Moreover, the LED module can be electrically connected to the external power source without using any conventional electrical connector, which has a complicated structure and is manufactured at high cost. According to the present invention, the manufacturing process of the LED light is simplified and the manufacturing cost of the LED light is lowered. Moreover, the LED module can be more securely electrically connected to the external power source to ensure the quality of the LED light.

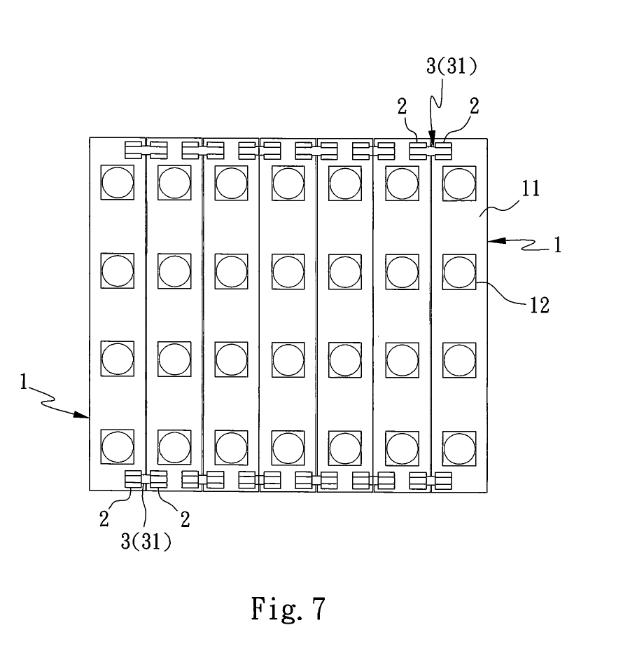

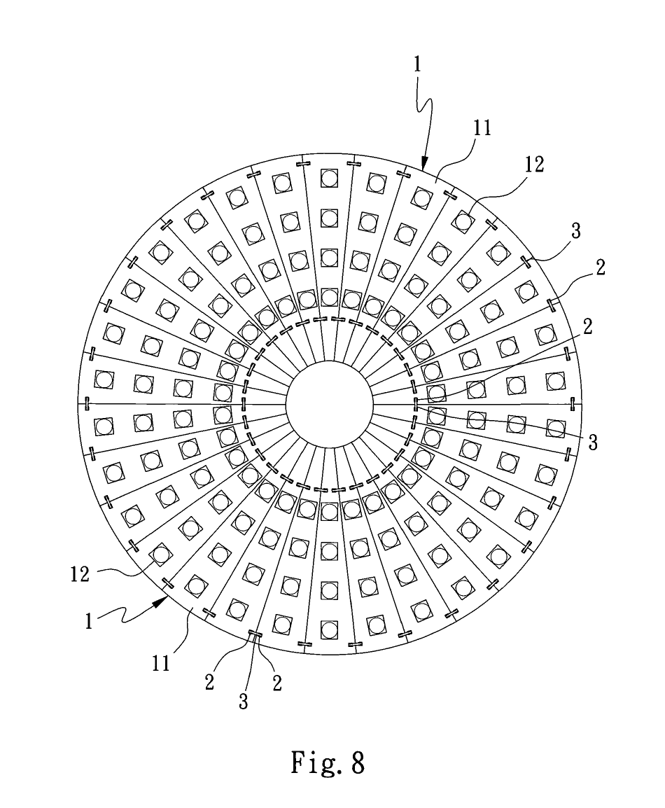

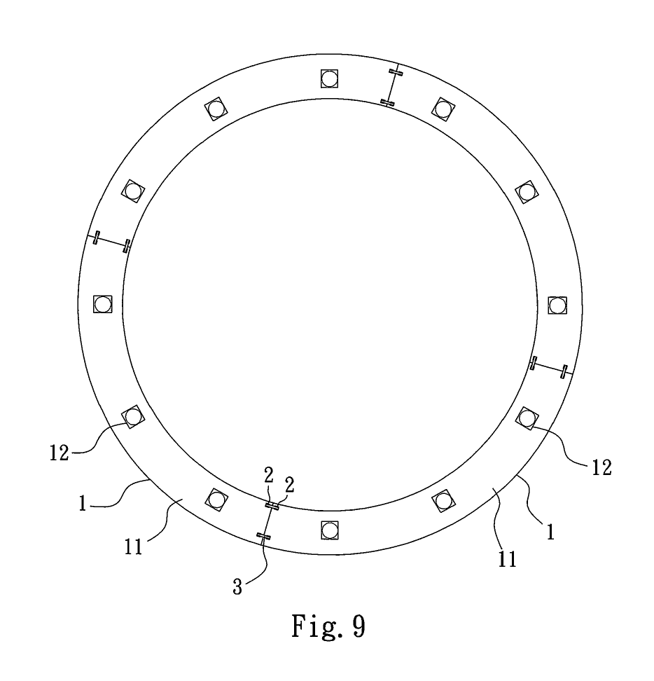

Please refer to FIGS. 5 and 6. More than two LED modules 1 can be assembled with each other by means of the connection seats 2 and the conductive connection members 3. More than two LED modules 1 can be assembled and electrically connected with each other via the conductive connection members 3 and the connection seats 2 without using any conventional fixing member (such as screw). Accordingly, the manufacturing process is simplified and the manufacturing cost is lowered. Further referring to FIG. 6, by means of the connection seats 2 and the conductive connection members 3, more than two LED modules 1 can be connected with each other to form an elongated assembly. Alternatively, as shown in FIG. 7, multiple LED modules 1 can be side by side connected with each other to form a rectangular assembly. Alternatively, as shown in FIG. 8, multiple LED modules 1 can be radially arranged and connected with each other to form a circular assembly. Alternatively, as shown in FIG. 9, multiple LED modules 1 can be connected with each other to form an annular assembly. Accordingly, multiple LED modules 1 can be assembled and electrically connected with each other and applied to an LED light.

In conclusion, in the LED module assembling structure of the present invention, by means of the connection seats 2 and the conductive connection members 3 applied to the LED modules 1, the manufacturing process of the LED light is simplified and the manufacturing cost of the LED light is lowered. Moreover, the LED modules can be more securely electrically connected to an external power source or connected with each other to ensure the quality of the LED light. The product according to the present invention can fully satisfy the current demands on the market.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. An LED module assembling structure comprising:
an LED module including a circuit board and at least one light-emitting diode connected to the circuit board;
at least one connection seat soldered on the circuit board of the LED module, the connection seat having a holding trough; and
a conductive connection member, which is a conductor in the form of a bar, one end of the conductive connection member being inserted in the holding trough of the connection seat and fixedly held in the holding trough, whereby the conductive connection member is electrically connected with the LED module via the connection seat.

2. The LED module assembling structure as claimed in claim 1, wherein the connection seat has two sidewalls defining the holding trough, the holding trough having an opening, the sidewalls being respectively formed with two corresponding recesses opposite to each other, the sidewalls being further respectively formed with two corresponding latch protrusion sections oppositely protruding from the sidewalls into the holding trough, the latch protrusion sections being positioned above the recesses near the opening.

3. The LED module assembling structure as claimed in claim 2, wherein the connection seat is made of metal material to directly electrically connect with the LED module.

4. The LED module assembling structure as claimed in claim 2, wherein the connection seat includes an insulation seat and at least one piece of conductive terminal connected to the recess, the conductive terminal being electrically connected with the LED module.

5. The LED module assembling structure as claimed in claim 1, wherein the conductive connection member is a metal bar.

6. The LED module assembling structure as claimed in claim 1, wherein the conductive connection member is an electrical wire.

7. An LED module assembling structure comprising:
more than two LED modules each including a circuit board and at least one light-emitting diode connected to the circuit board;
more than two connection seats respectively soldered on the circuit boards of the LED modules, each connection seat having a holding trough; and
a conductive connection member, which is a conductor in the form of a bar, two ends of the conductive connection member being respectively inserted in the holding troughs of the connection seats on the LED modules and fixedly held in the holding troughs, whereby the LED modules are electrically connected with each other via the conductive connection member and the connection seats.

8. The LED module assembling structure as claimed in claim 7, wherein the connection seat has two sidewalls defining the holding trough, the holding trough having an opening, the sidewalls being respectively formed with two corresponding recesses opposite to each other, the sidewalls being further respectively formed with two corresponding latch protrusion sections oppositely protruding from the sidewalls into the holding trough, the latch protrusion sections being positioned above the recesses near the opening.

9. The LED module assembling structure as claimed in claim 8, wherein the connection seat is made of metal material to directly electrically connect with the LED module.

10. The LED module assembling structure as claimed in claim 8, wherein the connection seat includes an insulation seat and at least one piece of conductive terminal connected to the recess, the conductive terminal being electrically connected with the LED module.

11. The LED module assembling structure as claimed in claim 7, wherein the conductive connection member is a metal bar.

12. The LED module assembling structure as claimed in claim 7, wherein the LED modules are connected with each other to form an elongated assembly.

13. The LED module assembling structure as claimed in claim 7, wherein the LED modules are side by side connected with each other to form a rectangular assembly.

14. The LED module assembling structure as claimed in claim 7, wherein the LED modules are radially arranged and connected with each other to form a circular assembly.

15. The LED module assembling structure as claimed in claim 7, wherein the LED modules are connected with each other to form an annular assembly.
